(19) United States
(12) Patent Application Publication
(10) Pub. No.: US 2026/0339005 A1
(43) Pub. Date: Oct. 29, 2026

(54) Metasurface optics with optimally packed meta-atoms incorporating a periodic phase component

(71) Applicant: APPLE INC., Cupertino, CA (US)

(72) Inventors: Maoz Ovadia, Kiryat Ono (IL); Moshe Kriman, Tel Aviv (IL); Aharon R. Barnea, Ramat Gan (IL)

(21) Appl. No.: 19/541,492

(22) Filed: Feb. 17, 2026

Related U.S. Application Data
(60) Provisional application No. 63/795,449, filed on Apr. 27, 2025.

(51) Int. Cl. G02B 5/18; G02B 1/00

(52) U.S. Cl. CPC G02B 5/1809; G02B 1/002; G02B 5/1847; G02B 2005/1804

(57) ABSTRACT

An optical device for diffracting light at a target wavelength. The device includes a substrate and an optical metasurface disposed on the substrate. The optical metasurface includes an array of pillars, which are arranged in a hexagonal lattice having a pitch no greater than half the target wavelength, and have varying respective diameters that are chosen to define a periodic pattern over a plane of the substrate having a unit cell larger than the target wavelength.

### CROSS-REFERENCE TO RELATED APPLICATION

This application claims the benefit of U.S. Provisional Patent Application 63/795,449, filed Apr. 27, 2025, which is incorporated herein by reference.

### FIELD OF THE INVENTION

The present invention relates generally to optical pattern projection, and particularly to optical elements used in pattern projection.

### BACKGROUND

Various sorts of portable computing devices, such as smartphones, augmented reality (AR) devices, virtual reality (VR) devices, smart watches, and smart glasses, comprise compact sources of optical radiation. Some of these sources may, for example, project patterned radiation (spot illumination) so as to illuminate the target region with a pattern of spots for purposes such as three-dimensional (3D) mapping of the region.

Optical metasurfaces are thin layers that comprise a two-dimensional pattern of structures, having dimensions (pitch and thickness) less than the target wavelength of the radiation with which the metasurface is designed to interact. Optical elements comprising optical metasurfaces are referred to herein as “metasurface optical elements” (MOEs).

U.S. Patent Application Publication 2024/0094437, whose disclosure is incorporated herein by reference, describes an optoelectronic apparatus, which includes an array of emitters configured to emit beams of optical radiation, an optical substrate mounted over the array, and an optical metasurface disposed on the optical substrate and configured to collimate and split each of the emitted beams into a respective group of collimated sub-beams, and to direct the collimated sub-beams toward a target to form a pattern of spots on the target.

The terms “optical rays,” “optical radiation,” “beams of optical radiation,” and “light,” as used in the present description and in the claims, refer generally to electromagnetic radiation in any or all of the visible, infrared, and ultraviolet spectral ranges.

### SUMMARY

Embodiments of the present invention that are described hereinbelow provide improved optical elements for use in projection of optical radiation.

There is therefore provided, in accordance with an embodiment of the invention, an optical device for diffracting light at a target wavelength. The device includes a substrate and an optical metasurface disposed on the substrate and including an array of pillars, which are arranged in a hexagonal lattice having a pitch no greater than half the target wavelength, and have varying respective diameters that are chosen to define a periodic pattern over a plane of the substrate having a unit cell larger than the target wavelength.

In some embodiments, the unit cell has a hexagonal shape. Alternatively, the unit cell has a parallelogram shape, such as a rectangular shape.

In some embodiments, the varying respective diameters of the pillars further define a functional phase variation having a non-periodic pattern across the plane of the substrate. The functional phase variation may be of a quadratic form, a bi-quadratic form, or a polynomial form of order three or more, for example. Alternatively or additionally, the functional variation is circularly symmetrical around a center point within the array.

There is also provided, in accordance with an embodiment of the invention, an optoelectronic apparatus, including one or more emitters configured to emit one or more beams of optical radiation at a target wavelength. A substrate is mounted to intercept the beams from the one or more emitters. An optical metasurface is disposed on the substrate and includes an array of pillars, which are arranged in a hexagonal lattice having a pitch no greater than half the target wavelength, and have varying respective diameters that are chosen to define a periodic pattern over a plane of the substrate having a unit cell larger than the target wavelength.

In a disclosed embodiment, the periodic pattern splits the one or more beams into a rectangular matrix of spots.

In some embodiments, the varying respective diameters of the pillars further define a functional phase variation having a non-periodic pattern across the plane of the substrate. In a disclosed embodiment, the functional phase variation applies a predefined focal power to the one or more beams.

There is additionally provided, in accordance with an embodiment of the invention, a method for fabricating an optical device for diffracting light at a target wavelength. The method includes forming on a substrate an optical metasurface including an array of pillars, which are arranged in a hexagonal lattice having a pitch no greater than half the target wavelength, and have varying respective diameters that are chosen to define a periodic pattern over a plane of the substrate having a unit cell larger than the target wavelength.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The present invention will be more fully understood from the following detailed description of the embodiments thereof, taken together with the drawings in which:

FIG. 1A is a schematic side view of an optoelectronic apparatus for pattern projection, in accordance with an embodiment of the invention;

FIG. 1B is a schematic frontal view of a target showing a pattern projected onto the target by the apparatus of FIG. 1A;

FIGS. 2A and 2B are respective schematic views of Type-1 and Type-2 hexagonal lattices, in accordance with an embodiment of the invention;

FIGS. 3A, 3B, 3C and 3D are schematic frontal views of two-dimensional unit cells on a Type-1 hexagonal lattice, in accordance with embodiments of the invention;

FIGS. 4A, 4B, 4C and 4D are schematic frontal views of two-dimensional unit cells on a Type-2 hexagonal lattice, in accordance with embodiments of the invention;

FIG. 5 is a schematic frontal view of a beamsplitter unit cell, in accordance with an embodiment of the invention;

FIG. 6 is a schematic frontal view of a beamsplitter, in accordance with an embodiment of the invention;

FIG. 7 is a schematic frontal view of an MOE combining a beamsplitter and a quadratic phase variation, in accordance with an embodiment of the invention;

FIG. 8 is a schematic frontal view of an MOE combining a beamsplitter and a biquadratic phase variation, in accordance with an embodiment of the invention; and

FIGS. 9A and 9B show respective plots comparing diffraction efficiencies of metasurfaces, in accordance with embodiments of the invention.

### DETAILED DESCRIPTION OF EMBODIMENTS

### Overview

In applications such as those described in the above-referenced U.S. Patent Application Publication 2024/0094437, optical metasurfaces are utilized to split and/or to focus beams of optical radiation. The structures of the metasurface, so-called meta-atoms, are designed to apply a local phase modulation to an impinging beam for achieving the desired functionality of splitting and/or focusing. These meta-atoms may comprise, for example, dielectric or semiconductor pillars (also referred to as “nanopillars”) or metallic resonators. The required phase modulation is achieved by varying the lateral dimensions of the meta-atoms.

The meta-atoms are arranged in an array having a center-to-center pitch d between the meta-atoms. In general, the efficiency of the metasurface for directing optical power to the desired output beams increases with decreasing pitch d. For good performance, the array of pillars on an optical metasurface typically has a pitch no greater than half the target wavelength for which the metasurface is designed.

A metasurface comprising silicon (Si) pillars in a medium of silicon oxide (SiO₂) is suitable for operation at near-infrared (NIR) wavelengths, such as λ=940 nm. The design rules of a typical fabrication process (such as deep-ultraviolet (DUV) lithography or nanoimprint lithography) used for fabricating these metasurfaces limit the diameters of the pillars, as well as their minimum spacing. Typical pillar pitches d between 380 nm and 470 nm are readily achievable by the processes described hereinabove.

Typically, to project a rectangular pattern on a target (such as a rectangular matrix of spots), a metasurface with pillars arranged on a rectangular lattice is used. The diffraction efficiency of such a metasurface is limited by the pillar density of d⁻² pillars per unit area, while the pillar pitch d is constrained by the fabrication process as explained above.

The embodiments of the present invention that are described herein increase the diffraction efficiency of the metasurface by fabricating the pillars on a hexagonal lattice, while the diameters of the pillars define a periodic pattern in the plane of the metasurface substrate. In the disclosed embodiments, the periodic pattern is formed by an array of parallelogram unit cells defined within the hexagonal lattice. The unit cells themselves may be rectangular, but are not necessarily so, as long as each of the four corners of each parallelogram is located at the center of a respective hexagonal cell of the lattice.

The use of a hexagonal lattice of meta-atoms to create a rectangular pattern achieves higher diffraction efficiency than can be achieved by a rectangular lattice of the same pitch. This improved performance is a result of the greater packing density of a hexagonal lattice with a given pitch d, compared to a rectangular lattice of the same pitch. In comparison to the above-described square lattice of pillars, the density of pillars per unit area in a hexagonal lattice is 2d⁻²/√3=1.15d⁻², which is 15% higher than the pillar density on the square lattice for the same pillar pitch d. An increase in the diffraction efficiency is especially useful when the metasurface is used for splitting an impinging optical beam into a fan of multiple beams.

In some embodiments, the varying diameters of the pillars of the metasurface additionally define a functional variation (such as a quadratic or biquadratic polynomial or another polynomial of order three or more). across the plane of the metasurface so as to apply optical power to a beam that is incident on the metasurface. For example, to focus or collimate the diffracted beams that form a matrix of spots on a target, the variation may be circularly symmetrical around a center point within the array of pillars. Alternatively, the center of symmetry of the functional variation may be offset from the center point of the array.

In further embodiments, the varying diameters of the pillars of the metasurface may additionally define other sorts of functional phase variations having a non-periodic pattern across the metasurface substrate.

### Optoelectronic Apparatus

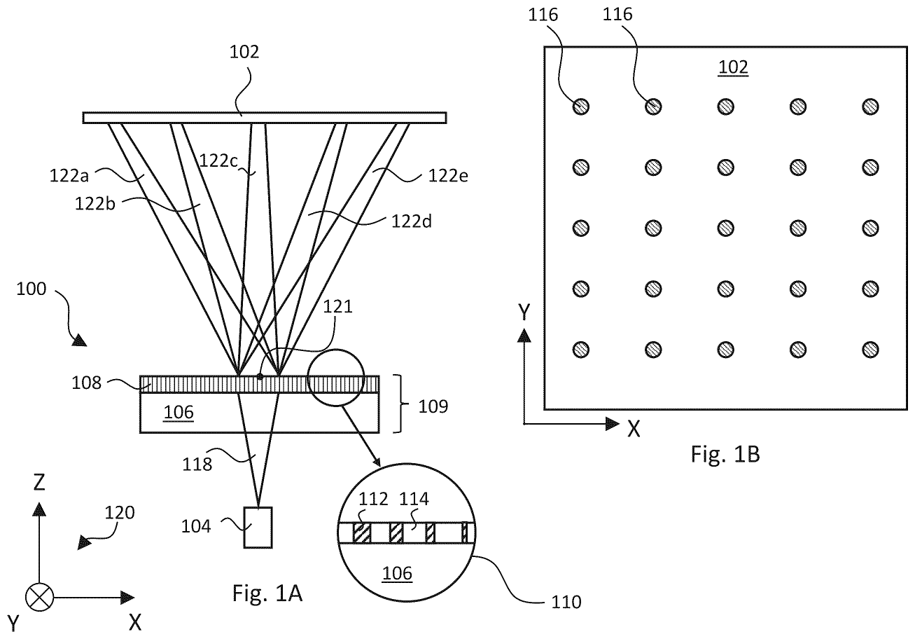

FIG. 1A is a schematic side view of an optoelectronic apparatus 100 for projecting a pattern onto a target 102, while FIG. 1B is a schematic frontal view of target 102, in accordance with an embodiment of the invention.

Optoelectronic apparatus 100 comprises a source 104, comprising one or more emitters, which emit beams of optical radiation at a target wavelength k. A substrate 106, which is transparent at the target wavelength, is mounted over the emitters, and a metasurface 108 disposed on the substrate. Substrate 106 and metasurface 108 together form a metasurface optical element (MOE) 109.

Source 104 comprises, for example, one or more vertical-cavity surface emitting lasers (VCSEL). Although FIG. 1A shows only a single beam emitted from source 104, the source may alternatively comprise an array of multiple emitters.

Substrate 106 comprises, for example, glass or any other suitable material that is transparent at the target wavelength k. Metasurface 108, shown in schematic detail in an inset 110, comprises an array of polysilicon (poly-Si) pillars 112 within a SiO₂ encapsulation 114. In alternative embodiments, pillars 112 may comprise other high-refractive-index semiconductor or dielectric material or metallic materials, and other materials may be used for the encapsulation, as well. Pillars 112 are arranged in a hexagonal lattice, as further detailed hereinbelow, with the diameters of the pillars designed to achieve periodic phase patterns in the X- and Y-directions (with reference to Cartesian coordinates 120) and thus generate a rectangular matrix of spots 116 on target 102. Optionally, the pillar diameters may also define a functional phase pattern having optical power, such as a quadratic or biquadratic phase pattern, symmetrical around a center point 121 of metasurface 108 so as to focus a beam of optical radiation impinging on the metasurface.

Metasurface 108 may be fabricated, for example, by depositing a layer of poly-Si over substrate 106, etching the poly-Si layer to form pillars 112 and then encapsulating the pillars in SiO₂ 114. Alternatively, metasurface 108 may be fabricated by depositing a layer of SiO₂ over substrate 106, etching holes in the SiO₂ layer and filling the holes with poly-Si.

For projecting a matrix of spots 116 on target 102 (FIG. 1B), source 104 emits a beam 118 of optical radiation at target wavelength λ in the Z-direction toward MOE 109. Beam 118 propagates through substrate 106 into metasurface 108, which splits the beam into a two-dimensional fan of beams diffracting in both X- and Y-directions. In the side view of FIG. 1A, five of these beams are shown: beams 122a, 122b, 122c, 122d and 122e. In addition to splitting beam 108 into the two-dimensional fan, each of the split beams is also focused, thus changing their respective diameters during their propagation. (Alternatively, the beams may be collimated by MOE 109 so as to preserve their respective diameters during propagation.) The two-dimensional fan of the beams forms an XY-raster of spots 116 on target 102, as shown in FIG. 1B.

Although in FIG. 1A MOE 109 is shown as an optically transmitting element, the same functionality may be alternatively provided by a reflective MOE. Thus, the MOEs referred to in the specifications and figures herein may comprise either transmissive or reflective MOEs.

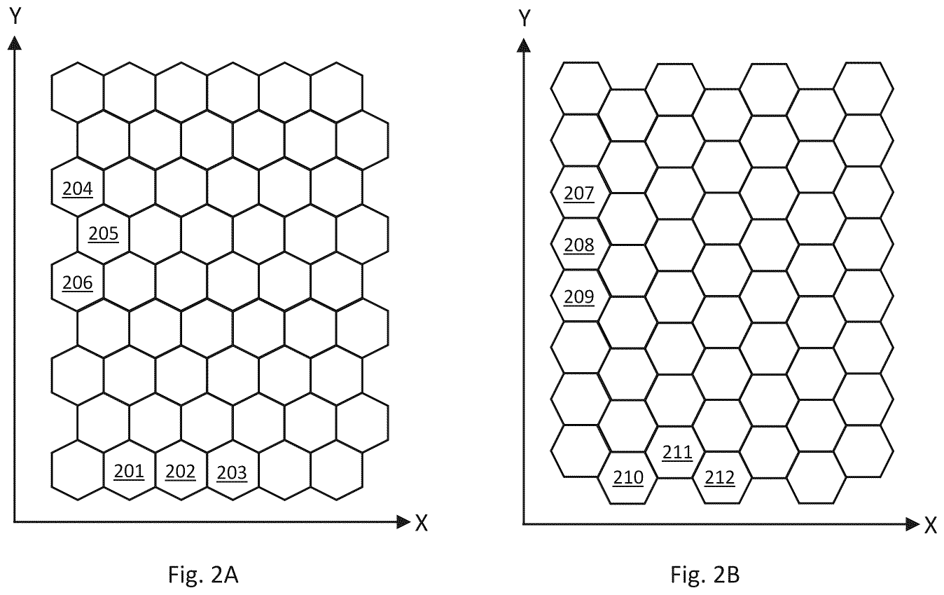

FIGS. 2A and 2B are respective schematic views of Type-1 and Type-2 hexagonal lattices, in accordance with an embodiment of the invention. A pillar 112 (as shown in FIG. 1A) is located at the center point of each hexagon in each of the lattices.

The two types of hexagonal lattices, Type-1 and Type-2, refer to the orientation of the hexagonal lattice with respect to the X- and Y-axes of Cartesian coordinates 120 (FIG. 1A). The type-1 hexagonal lattice, shown in FIG. 2A, has its hexagonal cells aligned along the X-axis, as shown, for example, by cells 201, 202 and 203. In the Y-direction, the cells of the Type-1 lattice form a zig-zag pattern, as shown, for example, by cells 204, 205 and 206.

The type-2 hexagonal lattice, shown in FIG. 2B, is obtained by rotating a Type-1 lattice by 90 degrees in the XY-plane. It has its hexagonal cells aligned along the Y-axis, as shown, for example, by cells 207, 208 and 209. In the X-direction, the cells of the Type-2 lattice form a zig-zag pattern, as shown, for example, by cells 210, 211 and 212.

### Unit Cells

The widths of pillars 112 of metasurface 108 (FIG. 1A) vary within a two-dimensional unit cell, which repeats periodically in two directions along the metasurface. In a general case, the unit cell has the shape of either a parallelogram or a hexagon, and, in order to fulfill the requirement of periodicity over the hexagonal lattice, each corner of the parallelogram or hexagon is located at the center of a respective hexagonal lattice cell. In the embodiments described hereinbelow, the unit cells are shown separately for a Type-1 lattice and for a Type-2 lattice.

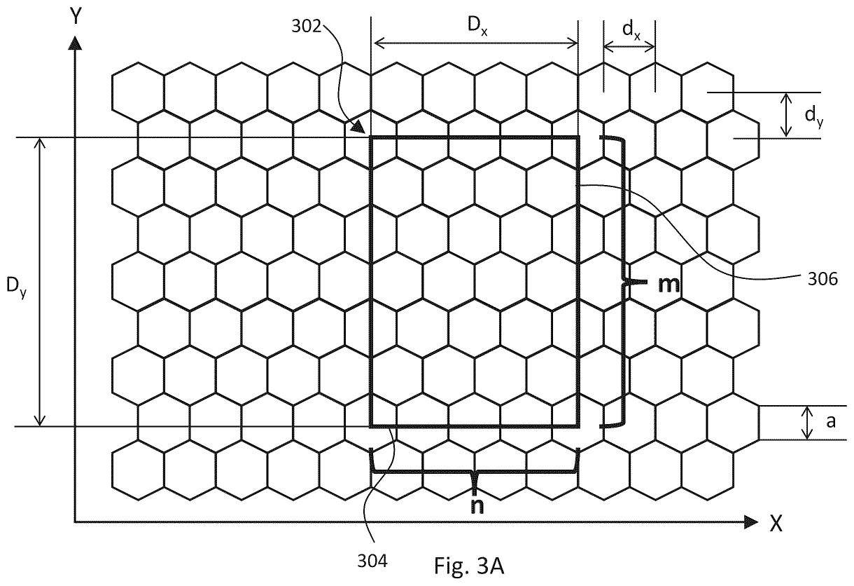

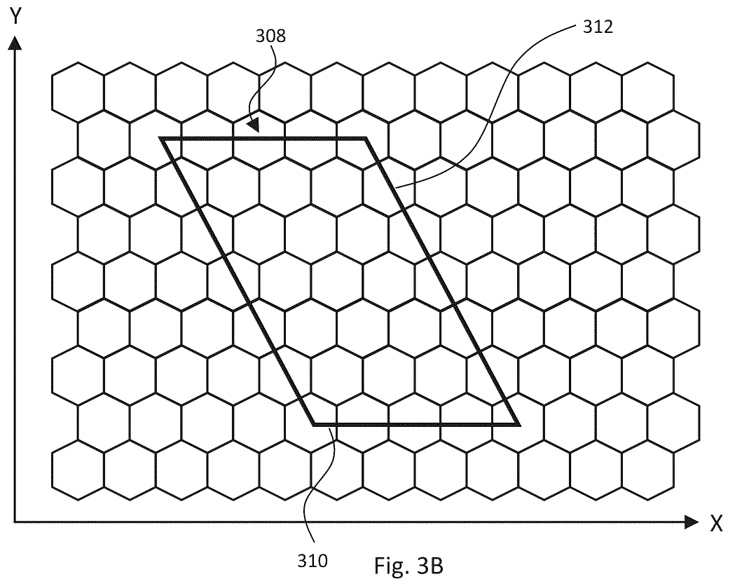

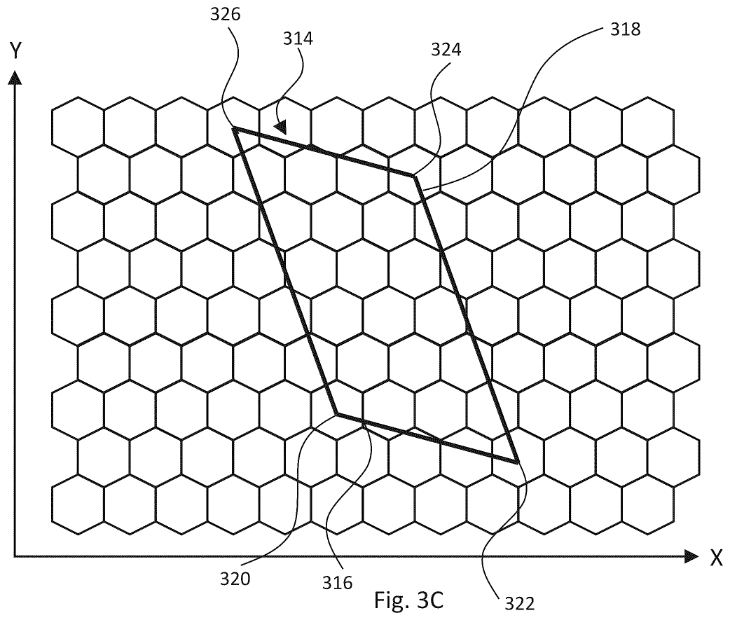

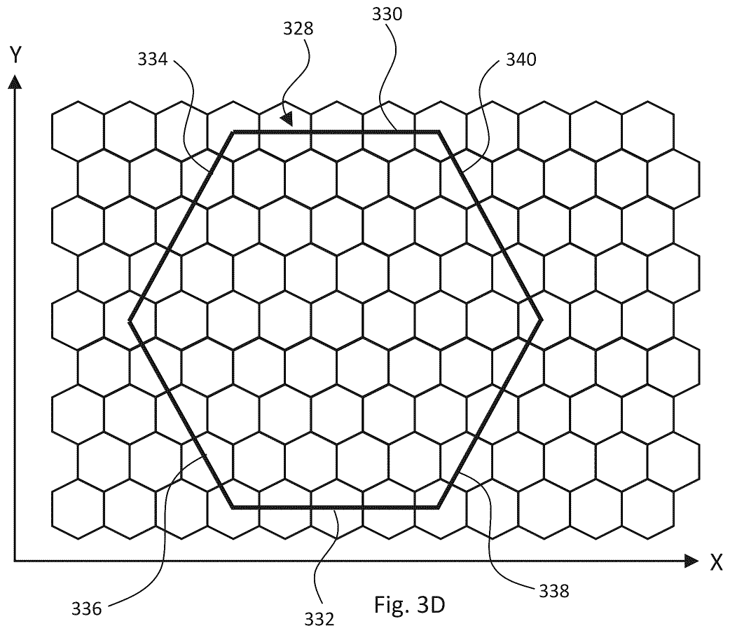

FIGS. 3A, 3B, 3C and 3D are schematic frontal views of two-dimensional unit cells on a Type-1 hexagonal lattice, in accordance with embodiments of the invention.

FIG. 3A shows a rectangular unit cell 302. A side 304 of unit cell 302, parallel to the X-axis, can comprise any suitable number n of hexagonal cells (i.e., meta-atoms), whereas a side 306, parallel to the Y-axis, can comprise only an even number m of hexagonal cells. The sizes of the unit cells determine the angular beam separation in the corresponding diffraction pattern, such as the pattern shown in FIG. 1B.

The hexagonal lattice has X- and Y-periods dₓ and d_{y}, respectively, which are less than half the target wavelength λ of the radiation with which the metasurface is designed to interact, while the X- and Y-dimensions Dx and Dy of unit cell 302, respectively, are both larger than λ. Similar relationships hold for the hexagonal lattices and unit cells in the further description and figures hereinbelow. (For an exact hexagonal lattice, the lattice periods dₓ and d_{y} are mutually dependent and may be written in terms of the side length a of the hexagon. For a Type-1 hexagonal lattice dₓ=a√3≅1.73a and d_{y}=1.5a. For a Type-2 hexagonal lattice the relationships are reversed.)

If specific unit cell dimensions, required for generating a desired diffraction pattern, cannot be obtained with a perfect hexagonal lattice of the pillars, the lattice may be re-scaled (“stretched”) in either the X- or Y-direction by a few percent without a significant deterioration of the performance of the metasurface.

FIG. 3B shows a parallelogram unit cell 308, wherein a side 310 is parallel to the X-axis and a side 312 is parallel to an oblique row of hexagonal lattice cells but not parallel to the Y-axis.

FIG. 3C shows a general oblique parallelogram unit cell 314, wherein the two sides 316 and 318 cross the hexagonal lattice cells in an arbitrary fashion. However, as noted hereinabove, each of four corners 320, 322, 324 and 326 of unit cell 314 is located at a center of a respective hexagonal cell of the lattice.

Unit cells 308 and 314 repeat across substrate 106 (FIG. 1A) in a rectangular or oblique pattern, to apply the desired rectangular phase pattern to the beam that is incident on metasurface 108. The use of non-rectangular unit cells can afford greater flexibility in choosing the angular pitch of the rectangular pattern. Alternatively, the non-rectangular unit cells may be arranged to repeat in an oblique (non-rectangular pattern), and thus generate an oblique phase pattern.

FIG. 3D shows a hexagonal unit cell 328. Sides 330 and 332 are parallel to the X-axis, and sides 334, 336, 338 and 340 cross respective oblique rows of hexagonal lattice cells. The use of hexagonal unit cells enables creating spot patterns with a hexagonal arrangement, for example.

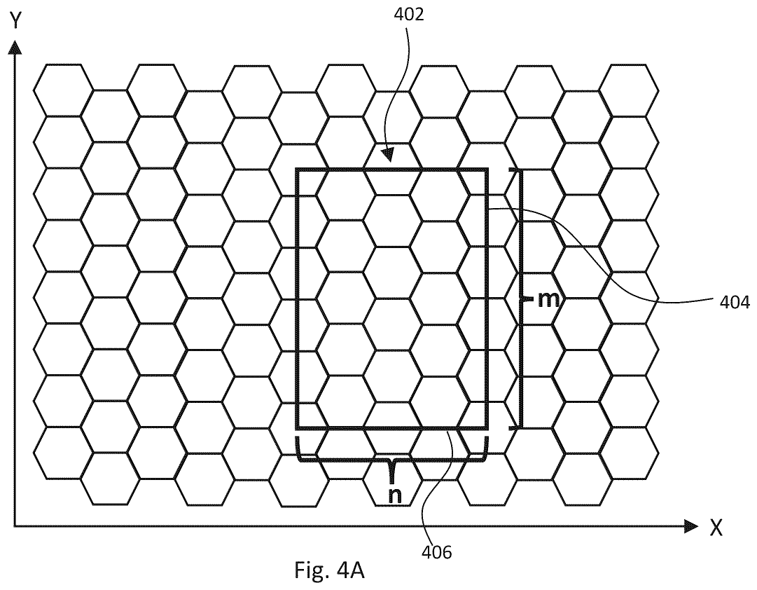

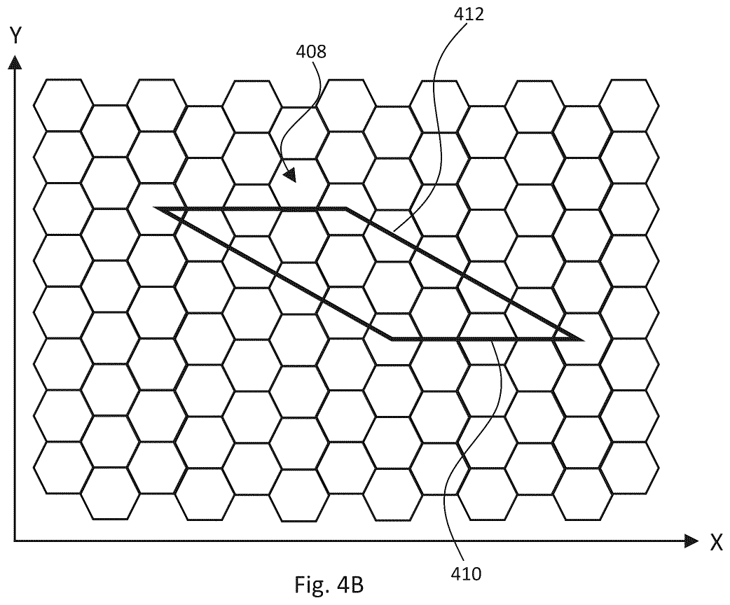

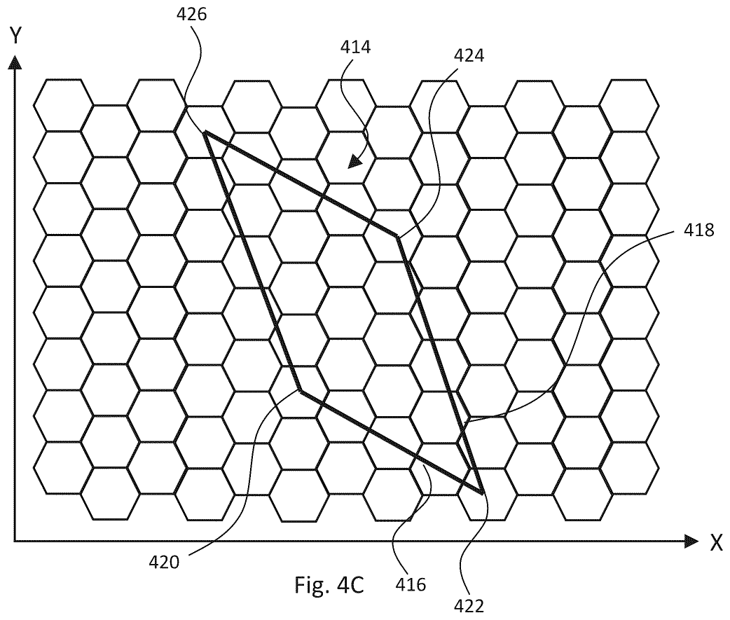

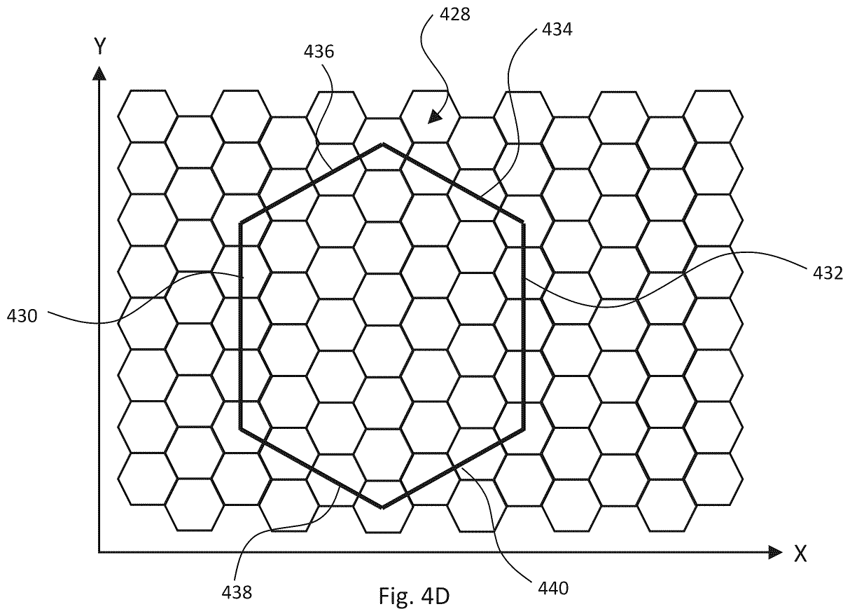

FIGS. 4A, 4B, 4C and 4D are schematic frontal views of two-dimensional unit cells on a Type-2 hexagonal lattice, in accordance with embodiments of the invention.

FIG. 4A shows a rectangular unit cell 402. A side 404, parallel to the Y-axis, can comprise any number m of hexagonal cells, whereas a side 406, parallel to the X-axis, can comprise only an even number n of hexagonal cells.

Similarly to rectangular unit cell 302 (FIG. 3A), the hexagonal lattice of the pillars may be stretched by a few percent to comply with requirements for the diffraction pattern.

FIG. 4B shows a parallelogram unit cell 408, wherein a side 410 is parallel to the X-axis and a side 412 is parallel to a row of hexagonal lattice cells but not parallel to the Y-axis.

FIG. 4C shows a general oblique parallelogram unit cell 414, wherein the two sides 416 and 418 cross the hexagonal lattice cells in an arbitrary fashion. Again, as described hereinabove, each of four corners 420, 422, 424 and 426 of unit cell 414 is located at a center of a respective hexagonal cells of the lattice.

Similarly to unit cells 308 and 314 (FIGS. 3B and 3C, respectively), unit cells 408 and 414 repeat across substrate 106 (FIG. 1A) in a rectangular or in an oblique pattern.

FIG. 4D shows a hexagonal unit cell 428. Sides 430 and 432 are parallel to the Y-axis, and sides 434, 436, 438 and 440 cross respective oblique rows of hexagonal lattice cells.

### Design Parameters

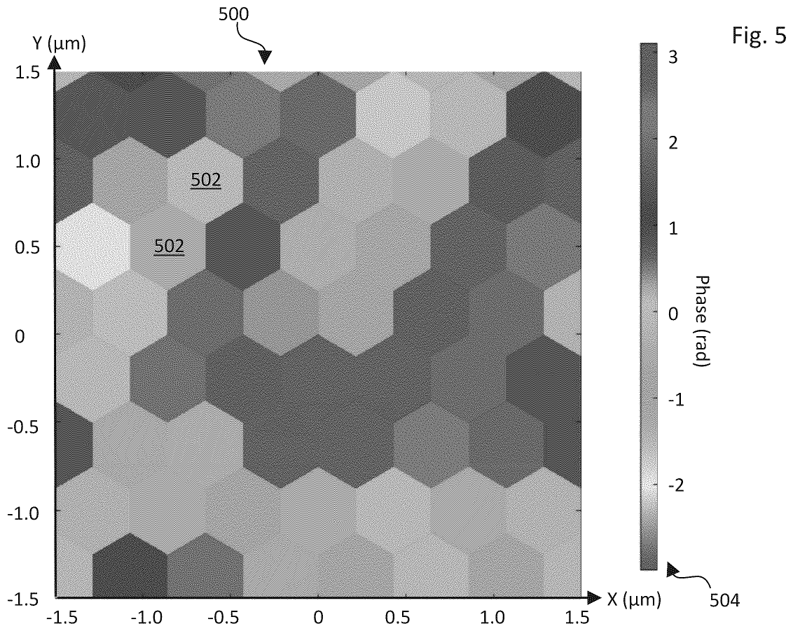

FIG. 5 is a schematic frontal view of a beamsplitter unit cell 500, in accordance with an embodiment of the invention. Unit cell 500 comprises 8×8 hexagonal lattice cells 502 with a square periodicity of 3 μm×3 μm. Each lattice cell 502 comprises a metasurface pillar, whose dimensions are selected to modulate the phase of an impinging optical wave by an amount indicated in radians by the color scheme of a legend 504. The phase modulation within unit cell 500 is designed to split an impinging wave in both X- and Y-directions into a 5×5 fan of beams.

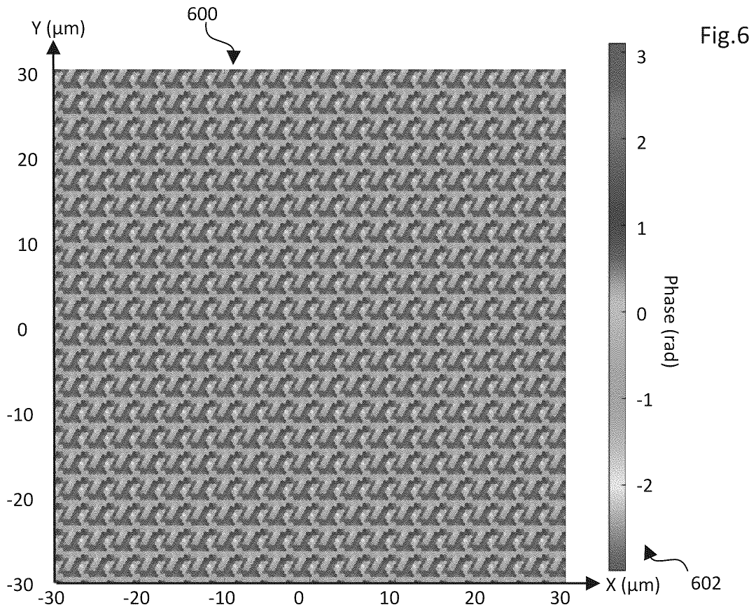

FIG. 6 is a schematic frontal view of a beamsplitter 600, in accordance with another embodiment of the invention. Beamsplitter 600 comprises a 20×20 array of beamsplitter unit cells 500, i.e., an arrangement wherein unit cell 500 has been replicated 20 times in both X- and Y-directions. Thus beamsplitter 600 comprises a 60 μm×60 μm MOE, which splits an impinging optical wave into a 5×5 fan of beams. Similarly to FIG. 5, the phase modulation produced by the hexagonal cells on the impinging optical wave is indicated by the colors of a legend 602.

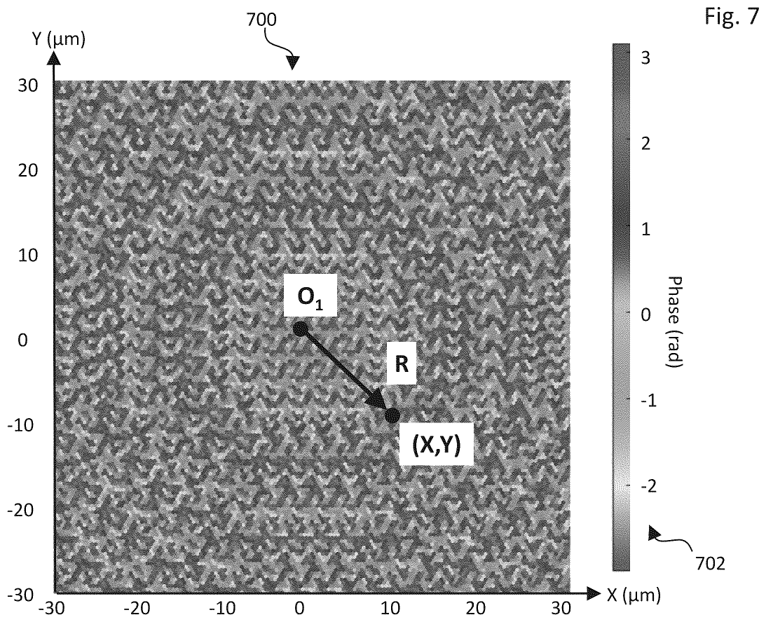

FIG. 7 is a schematic frontal view of an MOE 700 combining a beamsplitter and a quadratic phase variation, in accordance with an embodiment of the invention.

MOE 700 comprises a combination of beamsplitter 600 (FIG. 6) and a quadratic phase variation Φ₁ of the form Φ₁(X,Y)=α₁R², wherein R is a distance of a point (X,Y) from a center point Φ₁ of MOE 700 located at coordinates (0,0). Quadratic phase variation Φ₁ is defined by varying the diameters of the pillars of the metasurface of MOE 700. Phase variation Φ₁ is circularly symmetrical around center point O₁, providing MOE 700 with optical power (focusing) determined by the coefficient α₁. Thus MOE 700 both splits an impinging optical wave into a 5×5 fan of beams and focuses or collimates the split beams.

Similarly to beamsplitter 600, MOE 700 comprises a square of 60 μm×60 μm and the phase modulation produced by the hexagonal cells of the MOE on an impinging optical wave is indicated by the colors of a legend 702.

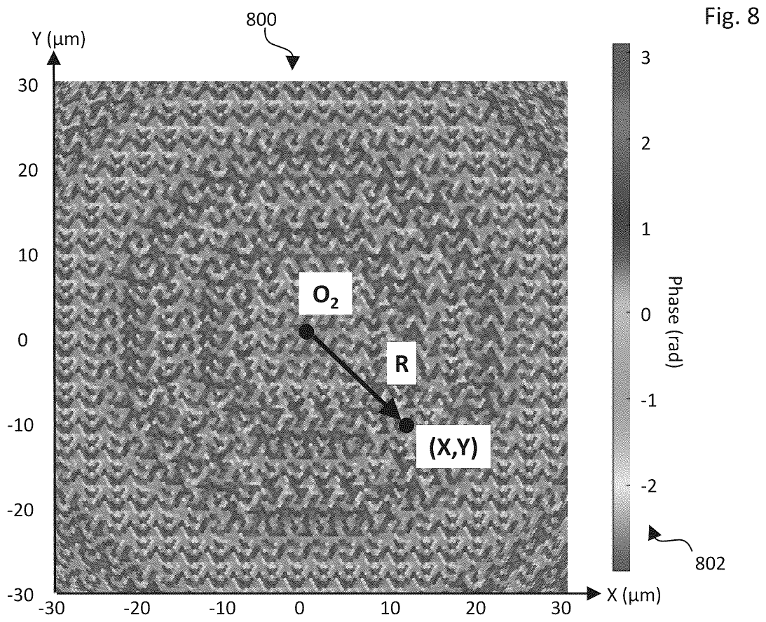

FIG. 8 is a schematic frontal view of an MOE 800 combining a beamsplitter and a biquadratic phase variation, in accordance with an embodiment of the invention.

MOE 800 comprises a combination of beamsplitter 600 (FIG. 6) and a biquadratic phase variation Φ₂ of the form Φ₂(X,Y)=α₂R²+β₂R⁴, wherein (similarly to FIG. 7) R is a distance of a point (X,Y) from a center point O₂ located at coordinates (0,0). Biquadratic phase variation Φ₂ is defined by varying the diameters of the pillars of the metasurface of MOE 800. Phase variation Φ₂ is circularly symmetrical around center point O₂, providing MOE 800 with optical power (focusing) determined by the coefficient α₂ as well as aspheric optical power determined by the coefficient β₂. Thus, MOE 800 splits an impinging optical wave into a 5×5 fan of beams, focuses or collimates the split beams, and additionally gives the respective wavefronts of the beams an aspheric form.

Similarly to beamsplitter 600 and MOE 700, MOE 800 comprises a square of 60 μm×60 μm, and the phase modulation produced by the hexagonal cells of the MOE on the impinging optical wave is indicated by the colors of a legend 802.

For the sake of illustration, both MOE 700 and MOE 800 have quadratic and biquadratic phases that vary relatively rapidly across the respective MOEs. Alternative embodiments may comprise quadratic and/or biquadratic phases with slower variations.

Further alternative embodiments may comprise MOEs, wherein the functional phase variation Φ is a polynomial of third or higher order in the radial distance R. Additional embodiments may comprise MOEs, wherein the center of symmetry of the functional phase variation Φ is offset from the center point of the MOE.

Other alternative embodiments may comprise MOEs, wherein the varying diameters of the pillars of the metasurface additionally define other sorts of functional phase variations having a non-periodic pattern across the MOE. diffraction efficiencies

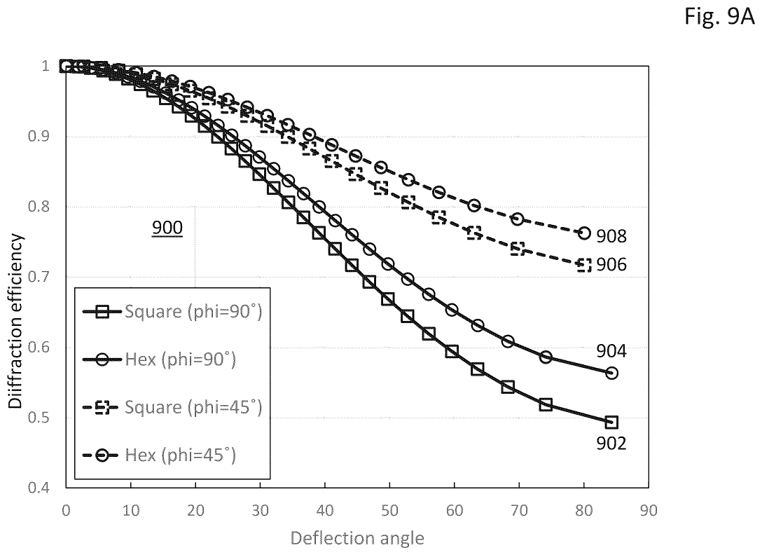

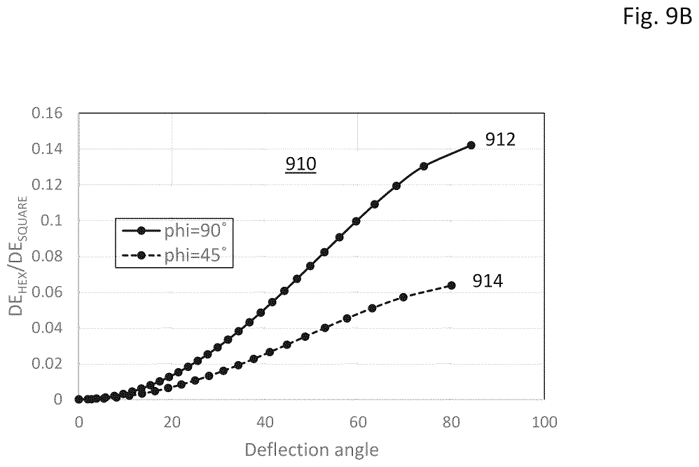

FIGS. 9A and 9B show respective plots comparing diffraction efficiencies of metasurfaces, in accordance with embodiments of the invention.

The metasurfaces of FIGS. 9A and 9B comprise linear phase gratings that are designed with pillars at the centers of the respective lattice cells (square or hexagonal) with a pillar-to-pillar spacing of d=0.45λ, wherein λ is the target wavelength of optical radiation impinging perpendicularly onto the respective gratings. The diameters of the pillars across the metasurfaces are designed to generate a linear phase variation across the respective surfaces, wherein the phases of the gratings are selected to generate deflection angles from 0° to 85° for gratings 1 and 2 (with reference to Table 1 hereinbelow) and from 0° to 80° for gratings 3 and 4. The directions of the equiphase lines of the gratings are given by an angle φ (phi), indicating the angle between the equiphase lines and the X-axis of Cartesian coordinates 120 (FIG. 1A).

In FIG. 9A, a plot 900 comprises four curves 902, 904, 906, and 908 showing computed diffraction efficiencies of respective linear phase gratings, whose properties are summarized in Table 1 hereinbelow:

TABLE 1
Properties of gratings in plot 900

| | Curve in | Direction of equiphase | Metasurface |
|---|---|---|---|
| | plot 900 | lines of the grating | pillar lattice |
| Grating 1 | 902 | Parallel to Y- | Square |
| | | axis (phi = 90°) | |
| Grating 2 | 904 | Parallel to Y- | Hexagonal Type-1 |
| | | axis (phi = 90°) | |
| Grating 3 | 906 | At 45° to X- and | Square |
| | | Y-axes | |
| | | (phi = 45°) | |
| Grating 4 | 908 | At 45° to X- and | Hexagonal Type-1 |
| | | Y-axes | |
| | | (phi = 45°) | |

From curves 902-908 it may be observed that the diffraction efficiencies decrease with increasing angles of deflection, with the diffraction efficiencies of gratings 2 and 4 (curves 904 and 908) consistently higher than those of gratings 1 and 3 (curves 902 and 906), respectively. These results demonstrate the advantage of the higher pillar density in a hexagonal metasurface lattice over that of a square lattice.

In FIG. 9B, a plot 910 shows computed ratios between the diffraction efficiencies of gratings on a hexagonal lattice and on a square lattice, respectively. A curve 912 shows the ratio between curves 904 and 902 (FIG. 9A), and a curve 914 shows the ratio between curves 908 and 906. The ratio of the diffraction efficiencies depends strongly on the deflection angle. The increase of the diffraction efficiency from a square lattice to a hexagonal lattice can exceed 14% for very high deflection angles for equiphase lines along the Y-axis (or X-axis, based on symmetry), whereas the increase for equiphase lines at 45° with respect to the Cartesian coordinate axes is approximately half of that value.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An optical device for diffracting light at a target wavelength, the device comprising:
a substrate; and
an optical metasurface disposed on the substrate and comprising an array of pillars, which are arranged in a hexagonal lattice having a pitch no greater than half the target wavelength, and have varying respective diameters that are chosen to define a periodic pattern over a plane of the substrate having a unit cell larger than the target wavelength.

2. The optical device according to claim 1, wherein the unit cell has a hexagonal shape.

3. The optical device according to claim 1, wherein the unit cell has a parallelogram shape.

4. The optical device according claim 3, wherein the unit cell has a rectangular shape.

5. The optical device according to claim 1, wherein the varying respective diameters of the pillars further define a functional phase variation having a non-periodic pattern across the plane of the substrate.

6. The optical device according to claim 5, wherein the functional phase variation is of a quadratic form.

7. The optical device according to claim 5, wherein the functional phase variation is of a bi-quadratic form.

8. The optical device according to claim 5, wherein the functional phase variation is of a polynomial form of order three or more.

9. The optical device according to claim 5, wherein the functional variation is circularly symmetrical around a center point within the array.

10. An optoelectronic apparatus, comprising:
one or more emitters configured to emit one or more beams of optical radiation at a target wavelength;
a substrate mounted to intercept the beams from the one or more emitters; and
an optical metasurface disposed on the substrate and comprising an array of pillars, which are arranged in a hexagonal lattice having a pitch no greater than half the target wavelength, and have varying respective diameters that are chosen to define a periodic pattern over a plane of the substrate having a unit cell larger than the target wavelength.

11. The apparatus according to claim 10, wherein the unit cell has a hexagonal shape.

12. The apparatus according to claim 10, wherein the unit cell has a parallelogram shape.

13. The apparatus according claim 12, wherein the unit cell has a rectangular shape.

14. The apparatus according to claim 12, wherein the periodic pattern splits the one or more beams into a rectangular matrix of spots.

15. The apparatus according to claim 10, wherein the varying respective diameters of the pillars further define a functional phase variation having a non-periodic pattern across the plane of the substrate.

16. The apparatus according to claim 15, wherein the functional phase variation applies a predefined focal power to the one or more beams.

17. The apparatus according to claim 15, wherein the functional phase variation is of a quadratic form.

18. The apparatus according to claim 15, wherein the functional phase variation is of a bi-quadratic form.

19. The apparatus according to claim 15, wherein the functional phase variation is of a polynomial form of order three or more.

20. A method for fabricating an optical device for diffracting light at a target wavelength, the method comprising:
forming on a substrate an optical metasurface comprising an array of pillars, which are arranged in a hexagonal lattice having a pitch no greater than half the target wavelength, and have varying respective diameters that are chosen to define a periodic pattern over a plane of the substrate having a unit cell larger than the target wavelength.
